(19) United States
(12) Patent Application Publication
(10) Pub. No.: US 2025/0118218 A1
(43) Pub. Date: Apr. 10, 2025

(54) APP-BASED GESTURES FOR NUMERICAL SUMMATION

(71) Applicant: Simon Allen, Aurora, CO (US)

(72) Inventor: Simon Allen, Aurora, CO (US)

(21) Appl. No.: 18/484,335

(22) Filed: Oct. 10, 2023

(51) Int. Cl. G09B 5/02; G06F 3/0486; G06F 3/04883; G09B 23/02

(52) U.S. Cl. CPC G09B 5/02; G06F 3/0486; G06F 3/04883; G09B 23/02

(57) ABSTRACT

Described herein are systems, methods, and other techniques for performing a user-assisted numerical summation at a user device. a user interface is displayed at the user device. A first addend is placed along the number line. A first number vector corresponding to a second addend is displayed within the user interface. A user swipe action is detected within the user interface, the user swipe action bisecting the first number vector into a second number vector and a third number vector. A first user drag-and-drop action is detected within the user interface, the first user drag-and-drop action causing the second number vector to be placed along the number line up to an intermediate sum. The third number vector is placed along the number line up to a summation result for the first addend and the second addend.

### BACKGROUND OF THE INVENTION

Mathematics education plays a pivotal role in fostering cognitive development and analytical thinking skills. Traditional teaching methods often rely on textbooks and classroom instruction, which may not effectively cater to diverse learning styles and individualized paces of learning. As technology continues to evolve, there is a growing demand for innovative educational tools that harness the capabilities of smartphones, enabling learners to access math-related content in a more personalized and accessible manner.

Various educational apps are available across app stores, ranging from basic arithmetic exercises to advanced calculus tutorials. However, many of these existing applications tend to focus on rote memorization or standardized test preparation, lacking the interactivity and adaptability needed to truly engage users and promote a deep understanding of mathematical concepts. Furthermore, the user interfaces of these apps can often be cumbersome and unintuitive, detracting from the overall learning experience.

### SUMMARY OF THE INVENTION

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).
Example 1 is a computer-implemented method of performing a user-assisted numerical summation at a user device, the computer-implemented method comprising: displaying a user interface at the user device, the user interface including a number line; placing a first addend along the number line; displaying a first number vector corresponding to a second addend within the user interface, the first number vector including a set of number elements; detecting a user swipe action within the user interface, the user swipe action bisecting the first number vector into a second number vector including a first portion of the set of number elements and a third number vector including a second portion of the set of number elements; detecting a first user drag-and-drop action within the user interface, the first user drag-and-drop action causing the second number vector to be placed along the number line adjacent to the first addend and up to an intermediate sum; and placing the third number vector along the number line adjacent to the second number vector and up to a summation result for the first addend and the second addend.
Example 2 is the computer-implemented method of example(s) 1, further comprising: receiving a user result via the user interface.
Example 3 is the computer-implemented method of example(s) 2, further comprising: in response to determining that the user result matches the summation result, displaying, within the user interface, an indication that the summation result is correct.
Example 4 is the computer-implemented method of example(s) 2, further comprising: in response to determining that the user result does not match the summation result, displaying, within the user interface, an indication that the summation result is incorrect.
Example 5 is the computer-implemented method of example(s) 2, wherein the user result is entered into the user interface using a writing tool.
Example 6 is the computer-implemented method of example(s) 1, further comprising: detecting a second user drag-and-drop action within the user interface, the second user drag-and-drop action causing the third number vector to be placed along the number line adjacent to the second number vector and up to the summation result.
Example 7 is the computer-implemented method of example(s) 1, wherein the first addend is less than the second addend.
Example 8 is a non-transitory computer-readable medium comprising instructions that, when executed by one or more processors, cause the one or more processors to perform operations for performing a user-assisted numerical summation at a user device, the operations comprising: displaying a user interface at the user device, the user interface including a number line; placing a first addend along the number line; displaying a first number vector corresponding to a second addend within the user interface, the first number vector including a set of number elements; detecting a user swipe action within the user interface, the user swipe action bisecting the first number vector into a second number vector including a first portion of the set of number elements and a third number vector including a second portion of the set of number elements; detecting a first user drag-and-drop action within the user interface, the first user drag-and-drop action causing the second number vector to be placed along the number line adjacent to the first addend and up to an intermediate sum; and placing the third number vector along the number line adjacent to the second number vector and up to a summation result for the first addend and the second addend.
Example 9 is the non-transitory computer-readable medium of example(s) 8, wherein the operations further comprise: receiving a user result via the user interface.
Example 10 is the non-transitory computer-readable medium of example(s) 9, wherein the operations further comprise: in response to determining that the user result matches the summation result, displaying, within the user interface, an indication that the summation result is correct.
Example 11 is the non-transitory computer-readable medium of example(s) 9, wherein the operations further comprise: in response to determining that the user result does not match the summation result, displaying, within the user interface, an indication that the summation result is incorrect.
Example 12 is the non-transitory computer-readable medium of example(s) 9, wherein the user result is entered into the user interface using a writing tool.
Example 13 is the non-transitory computer-readable medium of example(s) 8, wherein the operations further comprise: detecting a second user drag-and-drop action within the user interface, the second user drag-and-drop action causing the third number vector to be placed along the number line adjacent to the second number vector and up to the summation result.
Example 14 is the non-transitory computer-readable medium of example(s) 8, wherein the first addend is less than the second addend.
Example 15 is a system comprising: one or more processors; and a computer-readable medium comprising instructions that, when executed by the one or more processors, cause the one or more processors to perform operations for performing a user-assisted numerical summation at a user device, the operations comprising: displaying a user interface at the user device, the user interface including a number line; placing a first addend along the number line; displaying a first number vector corresponding to a second addend within the user interface, the first number vector including a set of number elements; detecting a user swipe action within the user interface, the user swipe action bisecting the first number vector into a second number vector including a first portion of the set of number elements and a third number vector including a second portion of the set of number elements; detecting a first user drag-and-drop action within the user interface, the first user drag-and-drop action causing the second number vector to be placed along the number line adjacent to the first addend and up to an intermediate sum; and placing the third number vector along the number line adjacent to the second number vector and up to a summation result for the first addend and the second addend.
Example 16 is the system of example(s) 15, wherein the operations further comprise: receiving a user result via the user interface.
Example 17 is the system of example(s) 16, wherein the operations further comprise: in response to determining that the user result matches the summation result, displaying, within the user interface, an indication that the summation result is correct.
Example 18 is the system of example(s) 16, wherein the operations further comprise: in response to determining that the user result does not match the summation result, displaying, within the user interface, an indication that the summation result is incorrect.
Example 19 is the system of example(s) 16, wherein the user result is entered into the user interface using a writing tool.
Example 20 is the system of example(s) 15, wherein the operations further comprise: detecting a second user drag-and-drop action within the user interface, the second user drag-and-drop action causing the third number vector to be placed along the number line adjacent to the second number vector and up to the summation result.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIGS. 1A-1F illustrate example steps for performing a user-assisted numerical summation at a user device.

FIGS. 2A-2N illustrate example steps for performing a user-assisted numerical summation at a user device.

FIGS. 3A-3G illustrate example steps for performing a user-assisted numerical summation at a user device.

FIG. 4 illustrates a method of performing a user-assisted numerical summation at a user device.

FIG. 5 illustrates s a simplified block diagram of a user device.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

For mathematics education, there are various educational apps available across app stores, ranging from basic arithmetic exercises to advanced calculus tutorials. Many of these existing applications tend to focus on rote memorization or standardized test preparation, failing to engage users and promote a deep understanding of mathematical concepts. Furthermore, the user interfaces of these apps can often be cumbersome and unintuitive, detracting from the overall learning experience.

The present invention relates to educational technology and more specifically to an application (or simply “app”) designed to facilitate interactive and engaging learning experiences for individuals seeking to enhance their understanding of mathematics. Some examples of the present invention relate to representing mental arithmetic using app-based gestures. In some instances, arithmetic can be simplified by partitioning one or both of the addends into two parts; one part that brings the intermediate sum up to 10, 20, 100, or some other reference number that is easy to be processed by a user and/or a user device, and another part that is referred to as the reminder, which is added to the intermediate sum to compute the summation result. If done correctly by the user, the summation result should be equal to the sum of the two addends.

For example, to compute the sum of 25 and 8, the smaller number can be partitioned into two parts, 5 and 3. The 5 can be added to the 25 to compute the intermediate sum of 30, and the remainder 3 can be added to the intermediate sum to compute a final sum of 33. As another example, to compute the sum of 18 and 9, the smaller number can be partitioned into two parts, 2 and 7. The 2 can be added to the 18 to compute the intermediate sum of 20, and the remainder 7 can be added to the intermediate sum to compute a final sum of 27. These computations can be performed at a user device to improve the efficiency of performing summations by the user device and/or the user.

Some embodiments of the present invention can be visualized on a user interface implemented by a display of a computer system. For example, embodiments can be visualized along a single dimension using a number line and along two dimensions using a grid (consisting of a number line wrapping to multiple rows). In some embodiments, summations are assisted by a combination of gestures from the user on the display. Such gestures may include swiping, tapping, pinching, zooming, dragging-and-dropping, rotating, and combinations thereof.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

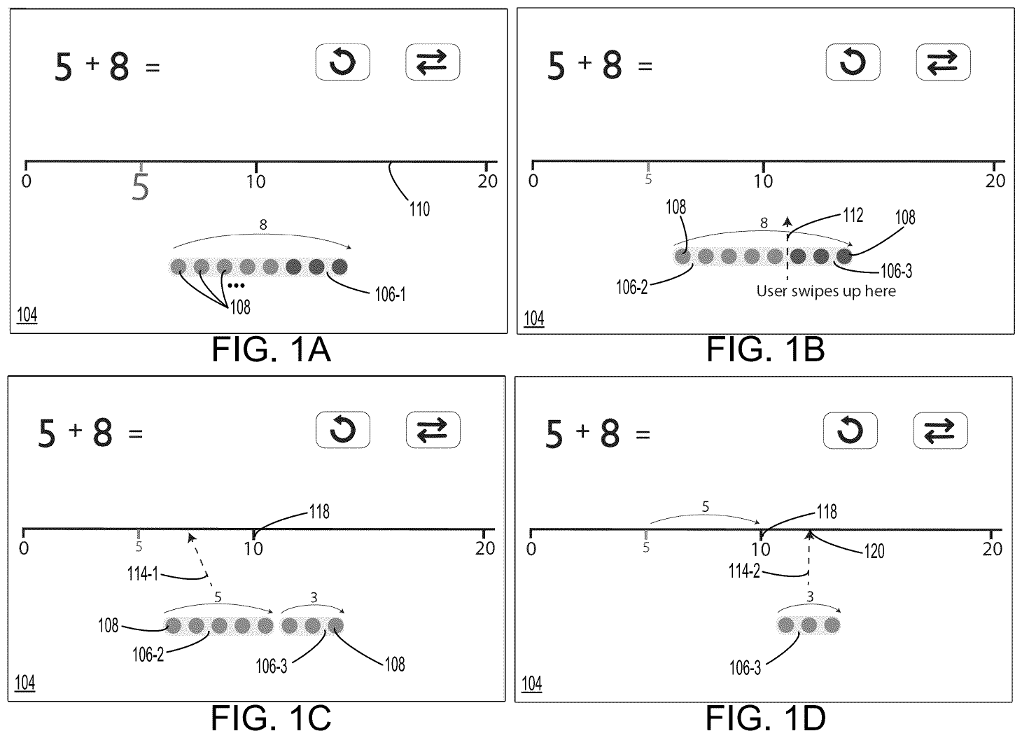

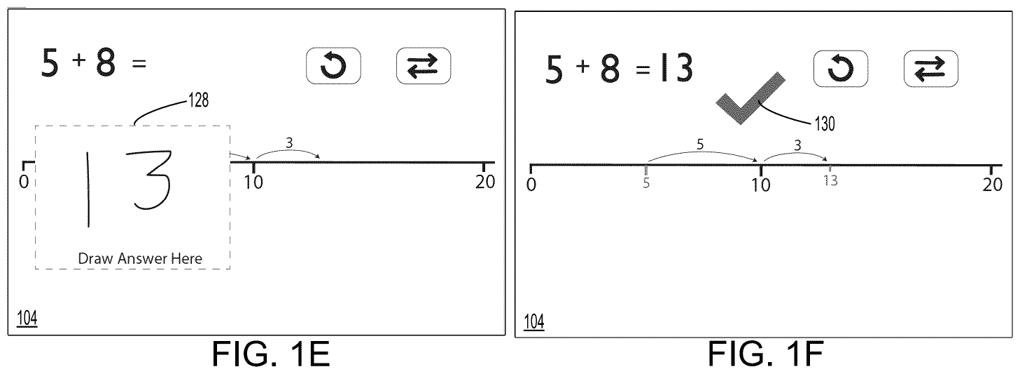

FIGS. 1A-1F illustrate example steps for performing a user-assisted numerical summation at a user device, in accordance with some embodiments of the present invention. In particular, a set of gestures are performed by a user at a display implementing a user interface 104 to perform a user-assisted numerical summation of the numbers 5 and 8.

In FIG. 1A, user interface 104 including a number line 110 is displayed and the number 5 is placed on a number line 110. Next, a number vector 106-1 including number elements 108 are generated for the number 8 and are displayed within user interface 104. In FIG. 1B, a user swipe action 112 that bisects number vector 106 is detected within user interface 104. User swipe action 112 may divide number vector 106-1 into number vector 106-2 and number vector 106-3, where number vector 106-2 includes a first portion of number elements 108 and number vector 106-3 includes a second portion of number elements 108.

In FIG. 1C, a user drag-and-drop action 114-1 is detected within user interface 104. User drag-and-drop action 114-1 may cause number vector 106-2 to be placed along number line 110 adjacent to the first addend (the number 5) and up to an intermediate sum 118 (the number 10). In FIG. 1D, a user drag-and-drop action 114-2 is detected within user interface 104. User drag-and-drop action 114-2 may cause number vector 106-3 to be placed along number line 110 adjacent to number vector 106-2 and up to a summation result 120 (the number 13).

In FIG. 1E, a user result 128 is received via user interface 104 by the user writing the number 13 in a drawing area using a writing tool in which lines follow the movement of the user's finger or writing utensil as it moves across user interface 104. In FIG. 1F, an indication 130 is displayed, showing that user result 128 (the number 13) matches summation result 120 (the number 13). If, on the other hand, it is determined that user result 128 does not match summation result 120, indication 130 may indicate that user result 128 is incorrect (e.g., by displaying an “X”).

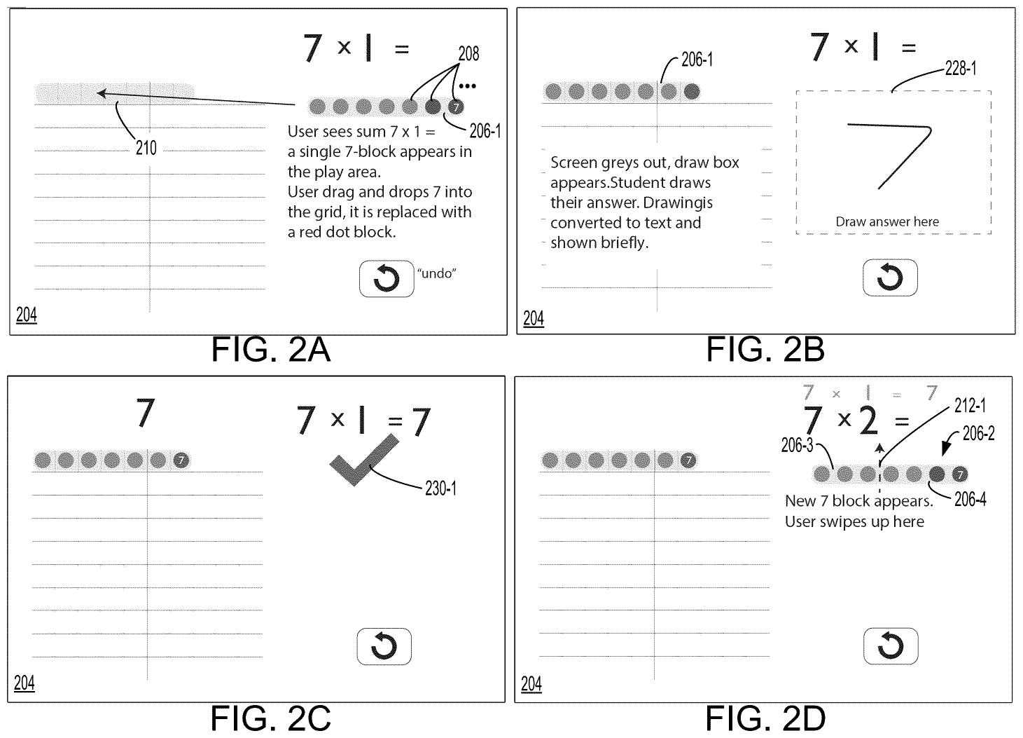

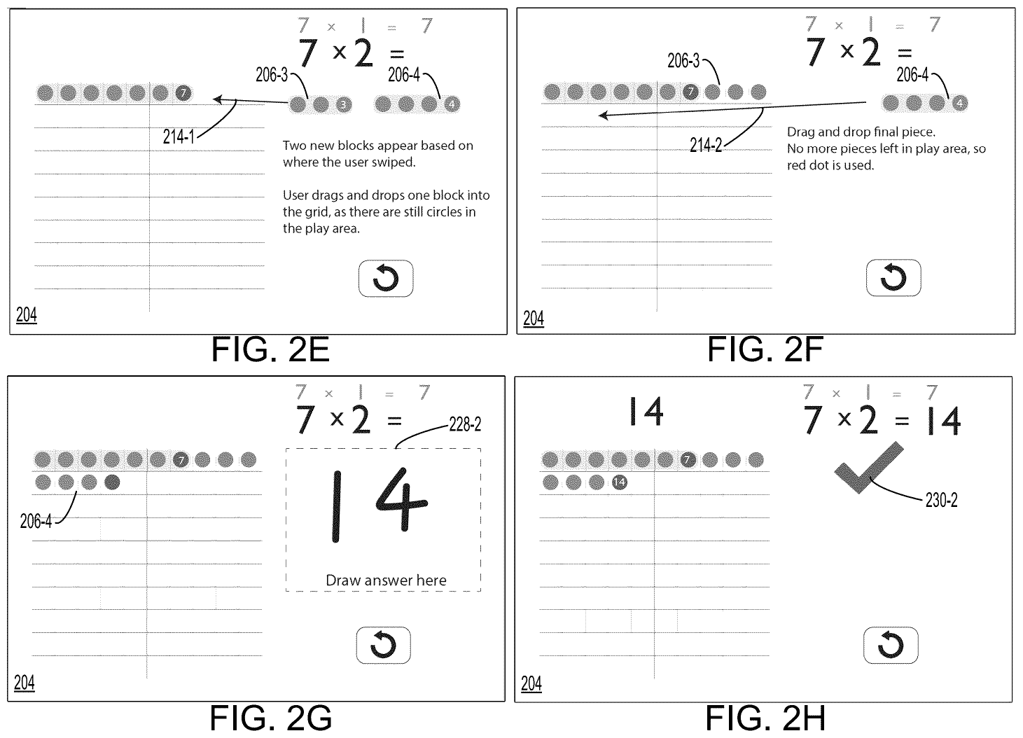

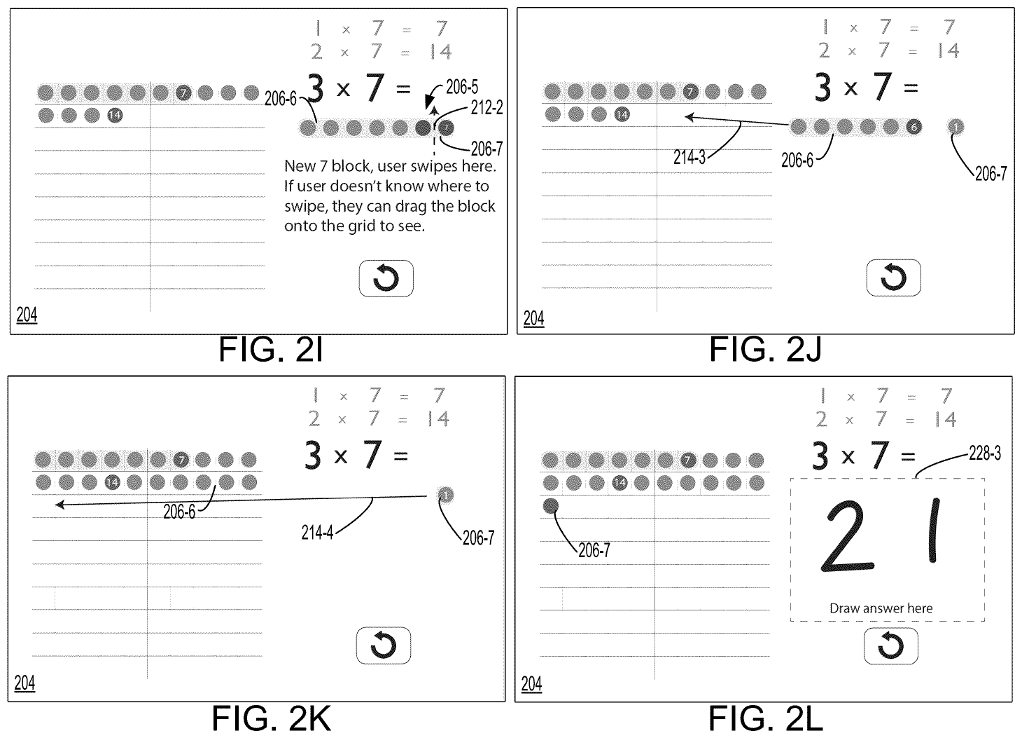

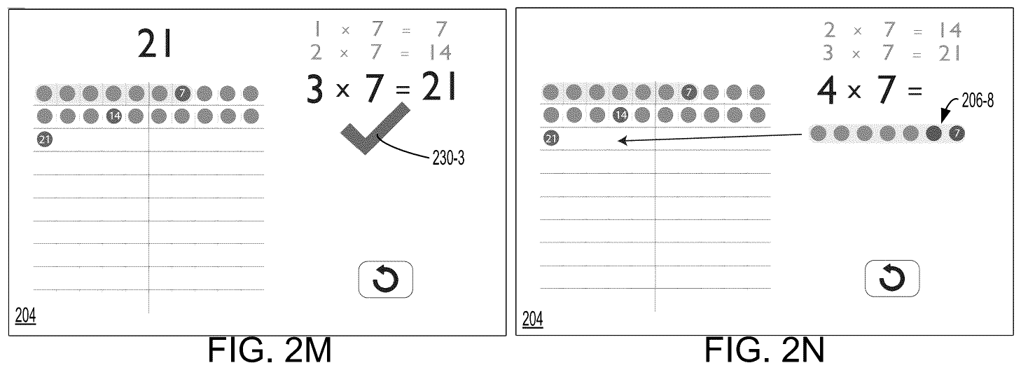

FIGS. 2A-2N illustrate example steps for performing a user-assisted numerical summation at a user device, in accordance with some embodiments of the present invention. In particular, a set of gestures are performed by a user at a display implementing a user interface 204 to perform user-assisted numerical summations and multiplications.

In FIG. 2A, user interface 204 including a number line 210 (represented across multiple rows within a grid) is displayed. Next, a number vector 206-1 including number elements 208 are generated for the number 7 and are displayed within user interface 204. Number vector 206-1 is placed on a number line 210. In FIG. 2B, a user result 228-1 is received via user interface 204 by the user writing the number 7 in a drawing area. In FIG. 2C, an indication 230-1 is displayed, showing that user result 228-1 (the number 7) matches a result.

In FIG. 2D, a number vector 206-2 including number elements 208 are generated for the number 7 and are displayed within user interface 204. A user swipe action 212-1 that bisects number vector 206-2 is detected within user interface 206. User swipe action 212-1 may divide number vector 206-2 into number vector 206-3 and number vector 206-4, where number vector 206-3 includes a first portion of number elements 208 and number vector 206-4 includes a second portion of number elements 208.

In FIG. 2E, a user drag-and-drop action 214-1 is detected within user interface 204. User drag-and-drop action 214-1 may cause number vector 206-3 to be placed along number line 210 adjacent to the first addend (the number 7) and up to an intermediate sum (the number 10). In FIG. 2F, a user drag-and-drop action 214-2 is detected within user interface 204. User drag-and-drop action 214-2 may cause number vector 206-4 to be placed along number line 210 adjacent to number vector 206-3 and up to a summation result (the number 14). In FIG. 2G, a user result 228-2 is received via user interface 204 by the user writing the number 14 in a drawing area. In FIG. 2F, an indication 230-2 is displayed, showing that user result 228-2 (the number 14) matches the summation result (the number 14).

In FIG. 2I, a number vector 206-5 including number elements 208 are generated for the number 7 and are displayed within user interface 204. A user swipe action 212-2 that bisects number vector 206-5 is detected within user interface 206. User swipe action 212-2 may divide number vector 206-5 into number vector 206-6 and number vector 206-7, where number vector 206-6 includes a first portion of number elements 208 and number vector 207-4 includes a second portion of number elements 208.

In FIG. 2J, a user drag-and-drop action 214-3 is detected within user interface 204. User drag-and-drop action 214-3 may cause number vector 206-6 to be placed along number line 210 adjacent to the second addend and up to an intermediate sum (the number 20). In FIG. 2K, a user drag-and-drop action 214-4 is detected within user interface 204. User drag-and-drop action 214-4 may cause number vector 206-7 to be placed along number line 210 adjacent to number vector 206-6 and up to a summation result (the number 21). In FIG. 2L, a user result 228-3 is received via user interface 204 by the user writing the number 21 in a drawing area. In FIG. 2M, an indication 230-3 is displayed, showing that user result 228-3 (the number 21) matches the summation result (the number 21). FIG. 2N shows how this technique can be continued by generating and displaying a number vector 206-8.

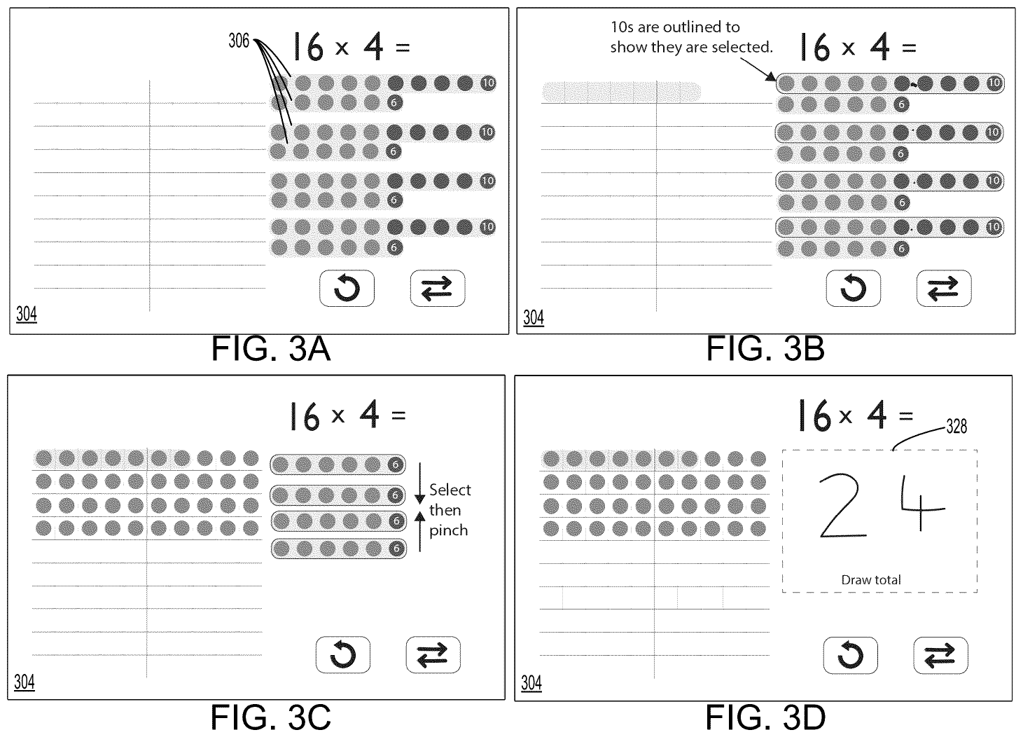

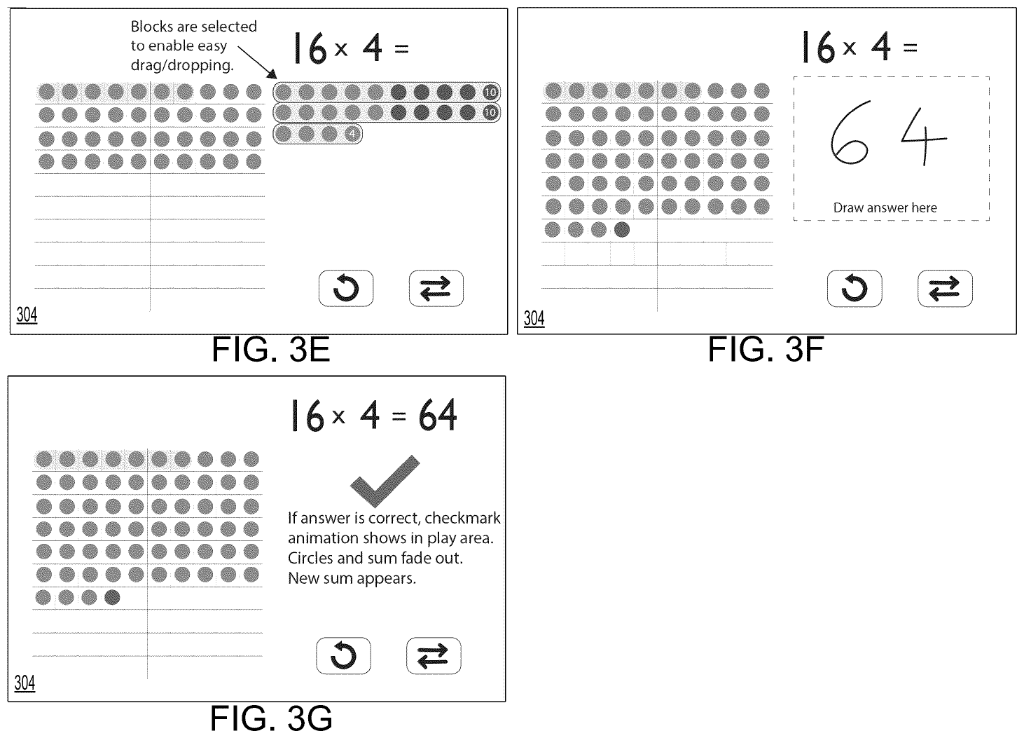

FIGS. 3A-3G illustrate example steps for performing a user-assisted numerical summation at a user device, in accordance with some embodiments of the present invention. In particular, a set of gestures are performed by a user at a display implementing a user interface 304 to perform user-assisted numerical summations and multiplications. The embodiments shown in FIGS. 3A-3G may include a “shuffle mode”, in which all number vectors 306 are displayed in the open area of user interface 304. Since the space in the open area may be limited, a user may need to tap on a particular number vector of number vectors 306 to select the particular number vector, and then swipe up or down to bisect the particular number vector. There may be some indication that one or more number vectors are selected, such as an outline as shown in FIG. 3B. In some instances, a user may hold their finger on the first 10 number vector and then tap the other 10 number vectors, or in other instances the user may long press the first 10 number vector and then release their finger to enter multiple select mode.

In FIG. 3C, a user can press and hold the first 6 number vector, or long press the first 6 number vector and then tap the other 6 number vectors to select all. With all selected, the user can perform a pinch gesture to combine the 6 number vectors. When the pinch gesture is used on multiple number vectors, the user may need to draw the correct total to combine them. When the user inputs a user result 328 by writing the number 24 in a drawing area, the text is displayed briefly before returning to the main screen. If user result 328 is incorrect, the screen shakes and returns to the main screen with the 6 number vectors and nothing is selected. In FIG. 3E, if the user draws the correct result, then the number vectors transform into an easily draggable form. The user can then drag and drop all the number vectors together. FIGS. 3F and 3G show additional example steps.

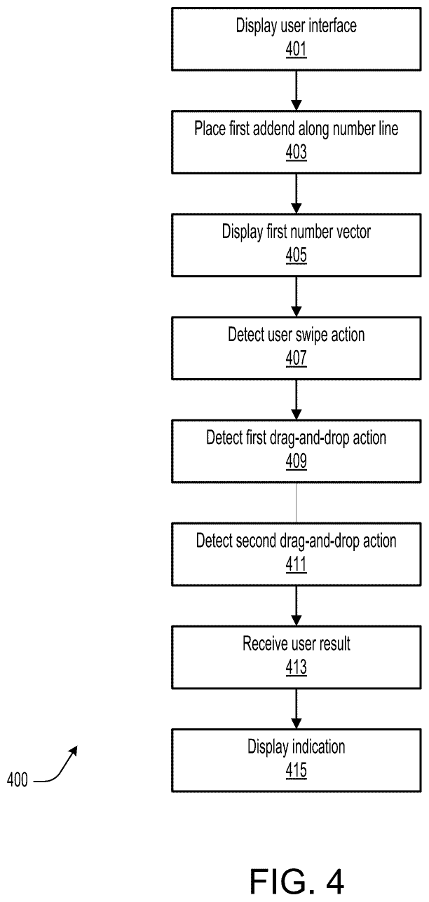

FIG. 4 illustrates a method 400 of performing a user-assisted numerical summation at a user device, in accordance with some embodiments of the present invention. Steps of method 400 may be performed in any order and/or in parallel, and one or more steps of method 400 may be optionally performed. One or more steps of method 400 may be performed by one or more processors. Method 400 may be implemented as a computer-readable medium or computer program product comprising instructions which, when the program is executed by one or more processors, cause the one or more processors to carry out the steps of method 400.
At step 401, a user interface is displayed at the user device. The user interface may include a number line.
At step 403, a first addend is placed along the number line.
At step 405, a first number vector corresponding to a second addend is displayed within the user interface. The first number vector may include a set of number elements.
At step 407, a user swipe action is detected within the user interface. The user swipe action may bisect the first number vector into a second number vector and a third number vector. The second number vector may include a first portion of the set of number elements and the third number vector may include a second portion of the set of number elements.
At step 409, a first user drag-and-drop action is detected within the user interface. The first user drag-and-drop action may cause the second number vector to be placed along the number line adjacent to the first addend and up to an intermediate sum.
At step 411, a second user drag-and-drop action is detected within the user interface. The second user drag-and-drop action may cause the third number vector to be placed along the number line adjacent to the second number vector and up to a summation result.
At step 413, a user result is received via the user interface.
At step 415, an indication that the summation result is correct is displayed in response to determining that the user result matches the summation result or an indication that the summation result is incorrect is displayed in response to determining that the user result does not match the summation result.

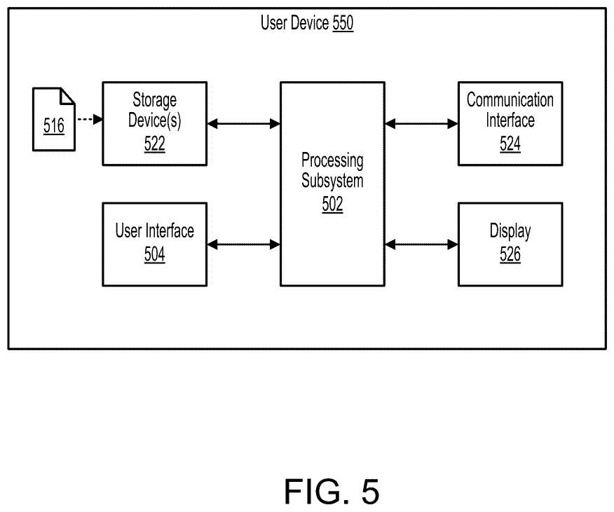

FIG. 5 illustrates s a simplified block diagram of a user device 550, according to some embodiments of the present invention. User device 550 can implement any or all of the functions, behaviors, and capabilities described herein, as well as other functions, behaviors, and capabilities not expressly described. User device 550 can include processing subsystem 502, storage device 522, user interface 504, communication interface 524, and display 526. User device 550 can also include other components (not explicitly shown) such as a battery, power controllers, and other components operable to provide various enhanced capabilities. In various embodiments, user device 550 can be a desktop computer, laptop computer, tablet computer, smart phone, other mobile phone, wearable computing device, or other systems having any desired form factor. In some examples, user device 550 can be a personal mobile device, which may be defined herein as a device that is both portable and capable of collecting, storing, transmitting, and/or processing electronic data or images.

Storage device 522 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. In some examples, storage device 522 may include a main memory, which may be directly accessible by one or more processors of processing subsystem 502 via address and data buses. For example, processing subsystem 502 may continuously read and execute instructions stored in storage device(s) 522. As such, various software elements may be loaded into storage device(s) 522 to be read and executed by processing subsystem 502. In some embodiments, the volatile memory of storage device(s) 522 is implemented as RAM, such as dynamic random-access memory (DRAM), and the non-volatile memory of storage device(s) 522 is implemented as read-only memory (ROM), such as flash memory, erasable programmable read-only memory (EPROM), or electrically erasable programmable read-only memory (EEPROM).

User interface 504 may include input devices such as a touch pad, touch screen, scroll wheel, click wheel, dial, button, switch, keypad, microphone, or the like, as well as output devices such as a video screen, indicator lights, speakers, headphone jacks, or the like, together with supporting electronics (e.g., digital to analog or analog to digital converters, signal processors, or the like). A user can operate input devices of user interface 504 to invoke the functionality of user device 550 and can view and/or hear output from user device 550 via output devices of user interface 504.

In some examples, user interface 504 is integrated with display 526. For example, when user device 550 is implemented as a smartphone or tablet, user interface 504 and display 526 may be integrated as a touchscreen that serve as the primary user interface. Users can interact with user device 550 by tapping and swiping display 526 to access apps, browse the web, send messages, and more. User interface 504 can include app icons, menus, keyboards, and various UI elements designed for touch interactions. As another example, display 526 can provide instructions for how a user can interact with user device 550 by pressing one of multiple physical buttons positioned along an edge of display 526.

Processing subsystem 502 can be implemented as one or more integrated circuits, e.g., one or more single core or multi core microprocessors or microcontrollers, examples of which are known in the art. In operation, processing subsystem 502 can control the operation of user device 550. In various embodiments, processing subsystem 502 can execute a variety of programs in response to program code and can maintain multiple concurrently executing programs or processes. At any given time, some or all of the program code to be executed can be resident in processing subsystem 502 and/or in storage media such as storage device(s) 522.

Communication interface 524 can provide voice and/or data communication capability for user device 550. In some embodiments communication interface 524 can include radio frequency (RF) transceiver components for accessing wireless voice and/or data networks (e.g., using cellular telephone technology, data network technology such as 3G, 4G/LTE, WiFi, other IEEE 802.11 family standards, or other mobile communication technologies, or any combination thereof), components for short range wireless communication (e.g., using Bluetooth and/or Bluetooth LE standards, NFC, etc.), and/or other components. In some embodiments communication interface 524 can provide wired network connectivity (e.g., Ethernet) in addition to or instead of a wireless interface.

Through suitable programming, processing subsystem 502 can provide various functionality for user device 550. For example, in some embodiments, processing subsystem 502 can implement various processes (or portions thereof) described above as being implemented by a user device. Processing subsystem 502 can also execute other programs to control other functions of user device 550, including application programs that may be stored in storage device 522.

Merely by way of example, one or more steps described with respect to any methods discussed above, may be implemented as instructions 516, which are executable by processing subsystem 502. In one example, such instructions 516 may be received by user device 550 using communication interface 524 (e.g., via a wireless or wired signal that carries instructions 516), carried by communication medium 524 to storage device(s) 522, stored within storage device(s) 522, read into the main memory of storage device(s) 522, and executed by processor subsystem 502 to perform one or more steps of the described methods.

In some embodiments of the present disclosure, instructions 516 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within user device 550. For example, the non-transitory computer-readable medium may be one of storage device(s) 522. In some cases, the non-transitory computer-readable medium may be separate from user device 550. In one example, the non-transitory computer-readable medium may be a removable medium provided to user device 550, such as an optical disc (e.g., Blu-ray discs, DVDs, CDs), a memory card (e.g., CompactFlash card, Secure Digital (SD) card, Memory Stick), a floppy disk, a Universal Serial Bus (USB) flash drive, or an external hard disk drive (HDD), with instructions 516 being read into user device 550.

Instructions 516 may take any suitable form to be read and/or executed by user device 550. For example, instructions 516 may be source code (written in a human-readable programming language such as Java, C, C++, C#, Python), object code, assembly language, machine code, microcode, executable code, and/or the like. In one example, instructions 516 are provided to user device 550 in the form of source code, and a compiler is used to translate instructions 516 from source code to machine code, which may then be read into the main memory of storage device(s) 522 for execution by processing subsystem 502. As another example, instructions 516 are provided to user device 550 in the form of an executable file with machine code that may immediately be read into the main memory of storage device(s) 522 for execution by processing subsystem 502. In various examples, instructions 516 may be provided to user device 550 in encrypted or unencrypted form, compressed or uncompressed form, as an installation package or an initialization for a broader software deployment, among other possibilities.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A computer-implemented method of performing a user-assisted numerical summation at a user device, the computer-implemented method comprising:
displaying a user interface at the user device, the user interface including a number line;
placing a first addend along the number line;
displaying, within the user interface, a first number vector represented by a first block of dots including a total number of dot elements equal to a value of a second addend;
detecting a user swipe action within the user interface, the user swipe action bisecting the first number vector into a second number vector represented by a second block of dots including a first number of dot elements less than the total number of dot elements, and a third number vector represented by a third block of dots including a second number of dot elements less than the total number of dot elements, wherein a sum of the first number of dot elements and the second number of dot elements is equal to the total number of dot elements;
detecting a first user drag-and-drop action within the user interface, the first user drag-and-drop action causing the second number vector to be placed along the number line adjacent to the first addend and up to an intermediate sum;
placing the third number vector along the number line adjacent to the second number vector and up to a summation result for the first addend and the second addend;
receiving, via the user interface, a user result;
determining whether the user result matches the summation result to obtain a determination result; and
displaying, within the user interface, a visual indication corresponding to the determination result.

2-4. (canceled)

2. The computer-implemented method of claim 1, wherein the user result is entered into the user interface using a writing tool.

3. The computer-implemented method of claim 1, further comprising:
detecting a second user drag-and-drop action within the user interface, the second user drag-and-drop action causing the third number vector to be placed along the number line adjacent to the second number vector and up to the summation result.

4. The computer-implemented method of claim 1, wherein the first addend is less than the second addend.

5. A non-transitory computer-readable medium comprising instructions that, when executed by one or more processors, cause the one or more processors to perform operations for performing a user-assisted numerical summation at a user device, the operations comprising:
displaying a user interface at the user device, the user interface including a number line;
placing a first addend along the number line;
displaying, within the user interface, a first number vector represented by a first block of dots including a total number of dot elements equal to a value of a second addend;
detecting a user swipe action within the user interface, the user swipe action bisecting the first number vector into a second number vector represented by a second block of dots including a first number of dot elements less than the total number of dot elements, and a third number vector represented by a third block of dots including a second number of dot elements less than the total number of dot elements, wherein a sum of the first number of dot elements and the second number of dot elements is equal to the total number of dot elements;
detecting a first user drag-and-drop action within the user interface, the first user drag-and-drop action causing the second number vector to be placed along the number line adjacent to the first addend and up to an intermediate sum;
placing the third number vector along the number line adjacent to the second number vector and up to a summation result for the first addend and the second addend;
receiving, via the user interface, a user result;
determining whether the user result matches the summation result to obtain a determination result; and
displaying, within the user interface, a visual indication corresponding to the determination result.

6-11. (canceled)

7. The non-transitory computer-readable medium of claim 8, wherein the user result is entered into the user interface using a writing tool.

8. The non-transitory computer-readable medium of claim 5, wherein the operations further comprise:
detecting a second user drag-and-drop action within the user interface, the second user drag-and-drop action causing the third number vector to be placed along the number line adjacent to the second number vector and up to the summation result.

9. The non-transitory computer-readable medium of claim 5, wherein the first addend is less than the second addend.

10. A system comprising:
one or more processors; and
a computer-readable medium comprising instructions that, when executed by the one or more processors, cause the one or more processors to perform operations for performing a user-assisted numerical summation at a user device, the operations comprising:
displaying a user interface at the user device, the user interface including a number line;
placing a first addend along the number line;
displaying, within the user interface, a first number vector represented by a first block of dots including a total number of dot elements equal to a value of a second addend;
detecting a user swipe action within the user interface, the user swipe action bisecting the first number vector into a second number vector represented by a second block of dots including a first number of dot elements less than the total number of dot elements, and a third number vector represented by a third block of dots including a second number of dot elements less than the total number of dot elements, wherein a sum of the first number of dot elements and the second number of dot elements is equal to the total number of dot elements;
detecting a first user drag-and-drop action within the user interface, the first user drag-and-drop action causing the second number vector to be placed along the number line adjacent to the first addend and up to an intermediate sum;
placing the third number vector along the number line adjacent to the second number vector and up to a summation result for the first addend and the second addend;
receiving, via the user interface, a user result;
determining whether the user result matches the summation result to obtain a determination result; and
displaying, within the user interface, a visual indication corresponding to the determination result.

11-18. (canceled)

12. The system of claim 15, wherein the user result is entered into the user interface using a writing tool.

13. The system of claim 10, wherein the operations further comprise:
detecting a second user drag-and-drop action within the user interface, the second user drag-and-drop action causing the third number vector to be placed along the number line adjacent to the second number vector and up to the summation result.

21. The system of claim 10, wherein the first addend is less than the second addend.
